(19) United States
(12) Patent Application Publication
(10) Pub. No.: US 2004/0025386 A1
(43) Pub. Date: Feb. 12, 2004

(54) Printed rigid multiple tags, printable with a thermal transfer printer for marking of electrotechnical and electronic elements

(76) Inventor: Ivana Piana, Predosa, AL (US)

Correspondence Address: Richard M. Goldberg, Suite 419, 25 East Salem Street, Hackensack, NJ, 07601, US

(21) Appl. No.: 10/213,566

(22) Filed: Aug. 7, 2002

(51) Int. Cl. G09F 3/00

(52) U.S. Cl. 40/316

(57) ABSTRACT

Printed multiple tags for marking electro technical and/or electronic elements manufactured from a rigid plate (1) consisting of various comb-shaped elements (1A, 1A′, 1B, 1B′) obtained by injection moulding of thermoplastic material, these comb-shaped components being separated and/or separable by through-passing cutting lines and/or non through-passing (2) pre-fracture lines separating the various interpenetrating teeth (3A, 3A′, 3B, 3B′, etc.) and by non-through pre-fracture lines (4) to facilitate detachment of the tooth assemblies (1A, 1A′, 1B, 1B′, etc.) and detachment of the printed tags (3A, 3A′, 3B, 3B′, etc.) from these comb shaped assemblies; these tags (3A, 3A′, 3B, 3B′, etc.) being marked by a thermal transfer printer, printing being coordinated by a computer controlled system; these marked tags are fitted in suitable supports (5), they are detached from their comb-shaped element and they are mounted on the electronic elements to be marked or may be detached and mounted on electronic elements already provided with a support.

This invention covers a marking system for electronic components (cables, systems, instruments, control panels etc.). Identification and marking systems consisting of elements or multiple tags on which characters or references are printed during production or by plotter based computer software have long been known. These marking systems, if compared with the manual composition of the marking elements permits fairly quick and accurate marking even for large marking series. However, plotter printing takes a rather long time as compared with the most recent printers now available on the market.

According to this invention, instead of the above described systems where the tags are composed of individual marking elements or computerised by plotter, the marking tags are now printed on prepacked rigid plastic plates with a thermal transfer printer.

According to this invention, this prepacked rigid plate features a set of crosswise arranged tags alternating with suitable, usually through-passing cutting lines and non through-passing prefracture lines.. These through-passing and non through-passing cutting lines permit to separate the various comb elements from the plate after it has been printed; these marking elements may then be fitted in special supporting sleeves or they may be directly applied to identify terminal blocks and contactors, etc.

The plate is in rigid thermoplastic material obtained by injection moulding in a way which permits its utilisation by a printer of the above described type.

The system, subject matter of this invention is illustrated in its practical and exemplified implementation in the attached drawings in which:

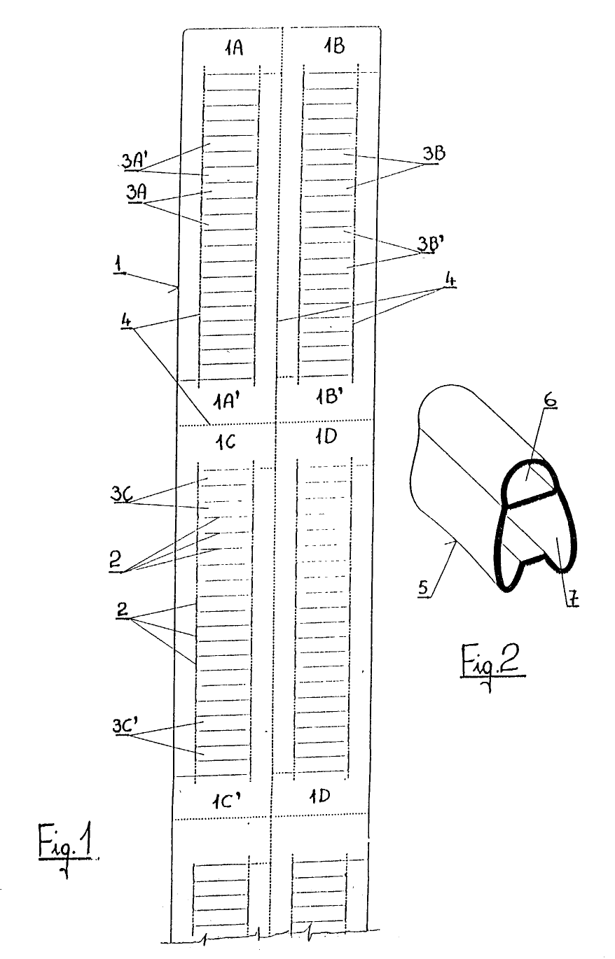

FIG. 1 shows a top view of an exemplified injection moulded plate;

FIG. 2 shows an exemplified marking sleeve;

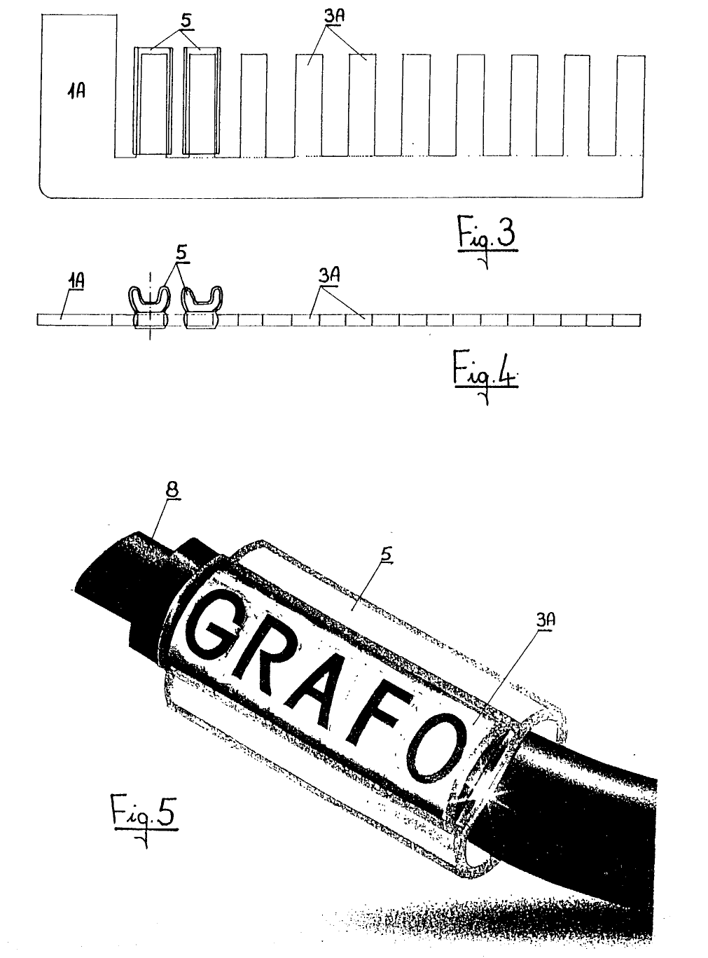

FIG. 3 shows a magnified top view of the comb-shaped device from which the marking elements are obtained;

FIG. 4 shows a side view of the comb-shaped element of FIG. 3;

FIG. 5 shows a perspective view of the marking tags used to identify a cable.

With reference to these Figures, the plate 1 consists of various components 1A,1A′, 1B,1B′, 1C,1C′, 1D,1D′, these components being obtained from one single plate 1 in rigid material such as injection moulded thermoplastic material. Cutting lines 2, which are usually through-passing but may also be non through passing, are provided to separate the interpenetrating teeth 3A,3A′, 3B,3B′, 3C,3C′, etc., of the comb, whereas non through-passing prefracture or precutting lines 4 are created to detach the various components, i.e. detachment of the comb-shaped units 1A,1A′, 1B,1B′, etc. and of the various single marking tags 3A,3A′, 3B,3B′, etc. from the comb. These non through-passing prefacture lines are indicated in the drawing by the dotted lines 4.

According to alternative solutions of this invention, the teeth may be separated by through-passing cutting lines 2 or by prefracture or pre-cutting lines 2 and this second solution permits to provide the printer with a plate 1 having a perfectly smooth lower surface resting on the printer.

After this definition of the plate assembly, the various characters required for marking may be printed on the tags which may then be separated from the comb assemblies 1A,1A′, 1B,1B′, etc. so that a support (sleeve) 5 may be placed on each tag; this sleeve features a recess 6 at its upper end in which to slip the marked tag, whereas the lower part of the sleeve is designed to secure the support to the electronic element to be identified. In the example, this lower portion 7 is designed to be mounted on medium/small sized cables 8 as shown in FIG. 3, whereas other configurations may be adopted for larger sized cables or for the marking of other electronic elements, as normally used.

The markings on the tags are printed with a thermal transfer printer specifically designed for rigid plates. After computer controlled printing with special software named SIMPLO 2000, the various comb assemblies are detached, the supporting sleeves are inserted as shown in FIGS. 3 and 4 and the tags and sleeves are then detached from their common comb-shaped support to be fitted on the items to be identified, while keeping in mind that these tags are also used to mark terminal blocks and contactors etc. already provided with a support. FIG. 5 shows, for example, the marking of a cable 8 featuring the exemplar word “GRAFO” printed on the tag.

The plate consisting of various comb units shown in FIG. 1 will usually consist of three consecutive elements and two elements placed abreast, but the number of consecutive and side by side positioned elements may also be varied.

These new marking tags are compatible with all normal and known marking elements already produced by the Applicant and may also be used in support or instead of the “Plotter System” series where a normal plotter is used for marking of the tags.

1) printed multiple tags for marking electro technical and/or electronic elements, characterised in that:
these tags are manufactured from a rigid plastic plate (1) consisting of several comb shaped units (1A,1A′, 1B,1B′ etc.), obtained by injection moulded of thermoplastic material,
these comb-shaped units (1A,1A′, 1B,1B′, etc.) being separated or separable by through passing cutting lines (2) separating the interpenetrating teeth (3A,3A′, 3B,3B′, etc.) and by non passing-through prefracture lines (4), to facilitate detachment of the comb units (1A,1A′, 1B,1B′, etc.) and detachment of the marked tags (3A,3A′, 3B,3B′, etc.) from each comb unit,
these tags (3A,3A′, 3B,3B′, etc.) are marked with the utilisation of a thermal transfer printer for rigid plates, printing being coordinated by a computerised system,
the printed tabs are placed in suitable supports (5), they are detached from their comb-shaped unit and they are fitted on the electronic elements to be identified or they may be directly detached and mounted on the electronic elements already provided with a support.

2) Printed multiple tags for marking electrotechnical and/or electronic elements as described in claim 1, characterised in that the through-passing lines (2) are replaced by non through-passing prefracture lines for the separation of the teeth of the plate.

3) Multiple tags as described in claim 1, characterised in that the marked tags are compatible with the marking material already available on the market.
